(19) United States
(12) Patent Application Publication
(10) Pub. No.: US 2021/0201229 A1
(43) Pub. Date: Jul. 1, 2021

(54) CYBERSECURITY QUANTITATIVE ANALYSIS SOFTWARE AS A SERVICE

(71) Applicant: Arx Nimbus LLC, Suite 300, IL (US)

(72) Inventors: DAVID MOON, Chicago, IL (US); George Wang, Chicago, IL (US); John Wiedermann, Chicago, IL (US)

(73) Assignee: Arx Nimbus LLC, Chicago, IL (US)

(21) Appl. No.: 17/058,047

(22) PCT Filed: May 22, 2019
(86) PCT No.: PCT/IB19/01020

§ 371 Date: Nov. 23, 2020

Related U.S. Application Data
(60) Provisional application No. 62/674,990, filed on May 22, 2018.

(51) Int. Cl. G06Q 10/06; G06F 21/57; G06F 9/54

(52) U.S. Cl. CPC G06Q 10/0635; G06F 2221/034; G06F 9/54; G06F 21/577

(57) ABSTRACT

A mathematically accurate cybersecurity risk analysis platform which is able to quantify the effects of cybersecurity risk in several inter-related dimensions, and accomplish this within established regulatory and audit-control frameworks, providing risk analyses which are not simply the function of professional judgement or expert opinion. The specific dimensions are between Threats, Risks, Vulnerabilities and Capabilities.

### FIELD OF THE DISCLOSURE

The present invention relates to quantitative risk analysis of cybersecurity capabilities, threats, vulnerabilities and risks, but not exclusively, the present invention relates to measurable risk impacts of the four key cybersecurity variables of Threat, Risk, Vulnerability, and Capabilities.

### BACKGROUND

Quantitative analysis of cybersecurity risks has been attempted using a variety of techniques. Most of these efforts have historically utilized a singular technique or approach, and have relied on the presumption of a normal distribution or conventional insurance methods used to quantify risks like natural disasters, fires, floods, etc. However, there is a problem in these past approaches. Increasingly, it is desirable to have correct mathematical modeling of adaptive threats, and to align with commonly accepted regulatory frameworks, and to be able to financially quantify risk, and to provide complete traceability to document these risk evaluations and their derivation.

Therefore, what is needed is a mathematically correct cybersecurity risk analysis platform which is able to quantify the effects of cybersecurity risk in several inter-related dimensions, and accomplish this within established regulatory and audit-control frameworks, providing risk analyses which are not simply the function of professional judgement or expert opinion.

Before proceeding, it should be appreciated that the present disclosure is directed to a system that may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

Therefore, it is an object, feature, or advantage of the present invention to improve over the state of the art.

It is a further feature, or advantage of the present invention to perform analysis of cybersecurity risks within the guidelines and defined structures of cybersecurity and data security regulatory frameworks principally at the federal level in the US, including those publicly proscribed by federal agencies including but not limited to the National Institute of Standards and Technology, the United States Treasury, the Department of Energy, the Department of Health and Human Services, and the Department of Homeland Security.

It is a further feature, or advantage of the present invention to perform analysis of cybersecurity risks through use of a unique mathematical algorithm which utilizes Probability Density distributions developed by the inventors from real-world data from actual cybersecurity threats, risks, vulnerabilities and capabilities.

It is a further feature, or advantage of the present invention to perform analysis of cybersecurity risks utilizing an unlimited set of cybersecurity evaluation technologies as inputs to the model and algorithm in the invention, to continue over time to provide greater amounts of data in its analysis and therefore greater meaningfulness from the analysis performed by the algorithm by operating as a software platform, incorporating both internal and external data sources using a probability rating equation to apply every potential data source to refine probabilities associated with cybersecurity risk.

It is a further feature, or advantage of the present invention to perform analysis of cybersecurity risks by a mechanism which combines and relates the relationships and interactions of standardized and published cybersecurity frameworks to allow the mapping of the interactions and relationships between these frameworks related to threats, risks, vulnerabilities and capabilities.

It is a further feature, or advantage of the present invention to perform analysis of cybersecurity risks in a fashion that allows the product to display graphically and visually the inter-relationships between threats, risks, vulnerabilities and capabilities, and to illustrate those relationships and to allow the user to portray what-if analyses on these relationships to show the effects on any of these four dimensions financially (threat, risk, vulnerability and capability), as changes are made to any of the dimensions.

### BRIEF DESCRIPTION OF THE DRAWINGS

FIG. 1 shows an Interactive Heat Map in accordance with an embodiment of the disclosed principles;

FIG. 2 shows a quantification process flow in accordance with an embodiment of the disclosed principles;

FIG. 3 shows a flexible architecture for accommodating multiple regulatory frameworks in accordance with an embodiment of the disclosed principles;

FIG. 4 shows an alternative process flow in accordance with an embodiment of the disclosed principles;

FIG. 5 shows another alternative process flow in accordance with an embodiment of the disclosed principles;

FIG. 6 shows a self-insurance price risk valuation model in accordance with an embodiment of the disclosed principles;

FIG. 7 shows an example event density in accordance with an embodiment of the disclosed principles; and

FIG. 8 shows a self-insurance price model (Continued) in accordance with an embodiment of the disclosed principles.

### DETAILED DESCRIPTION

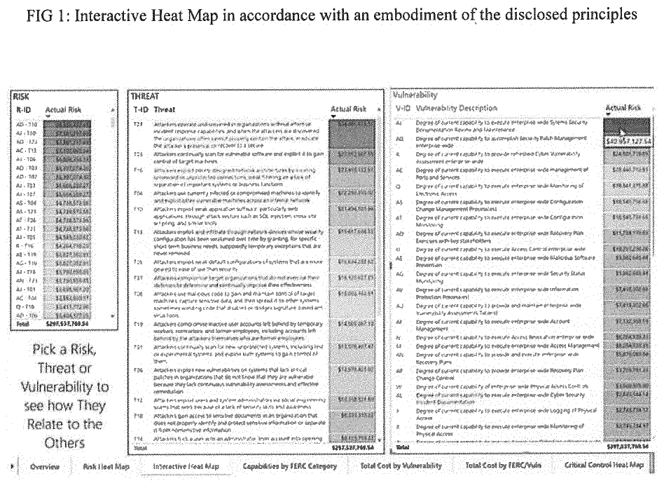

FIG. 1 is the Interactive Heat Map, which is a visualization that allows the user to identify the relationships between Threats and Vulnerabilities which define specific Risk Pairings. We define Risk=Threats+Vulnerability (An unique pairing of one threat to one vulnerability defines an unique Risk)

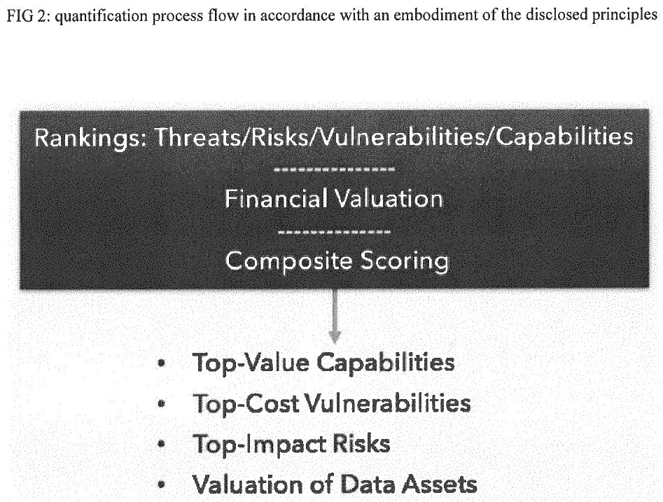

FIG. 2 is Quantification Process where the left side elements are the inputs and the right side elements are the outputs. Our mathematical algorithms reside in the middle process block.

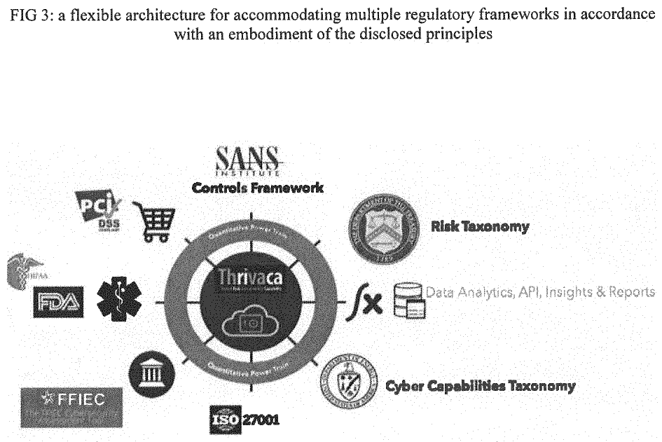

FIG. 3 is our flexible architecture view of the Thrivaca core engine and platform which accommodates multiple regulatory frameworks. Our model is not limited to a single framework, which competitors may utilize. Our architecture also accommodates different output views or what we call output lenses.

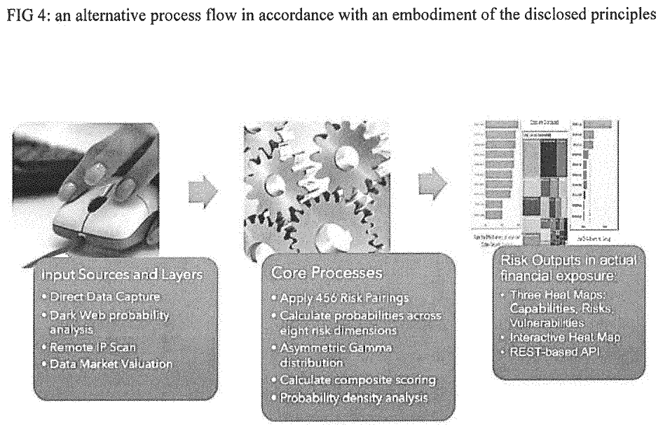

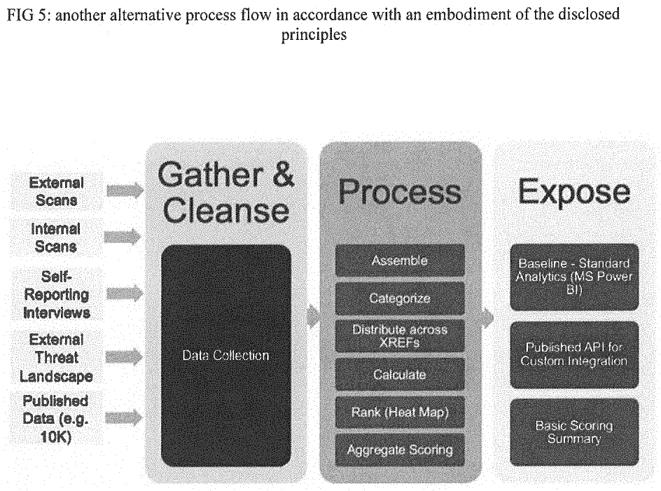

FIGS. 4 and 5 are additional process flow views.

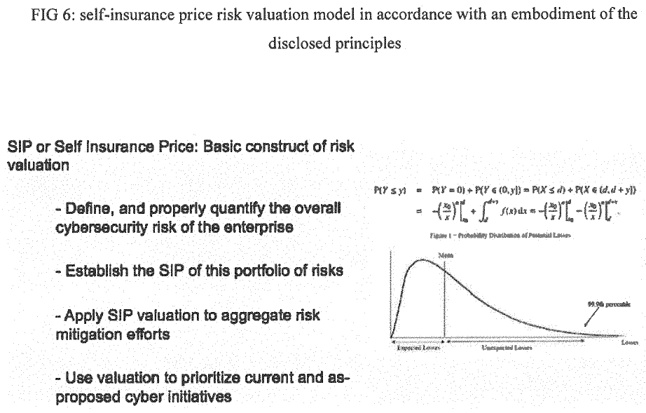

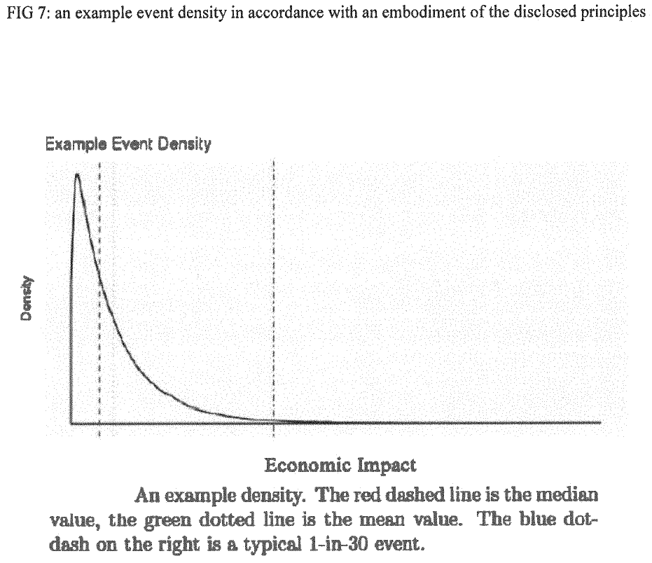

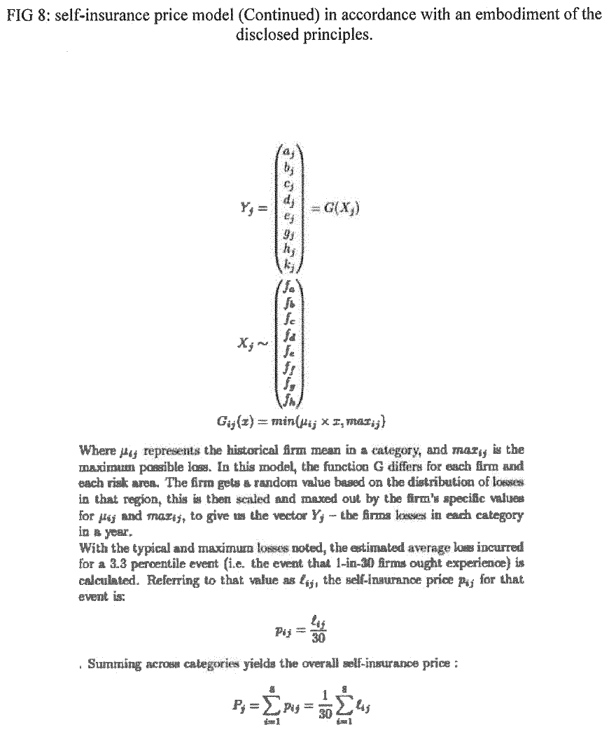

FIGS. 6, 7 and 8 describe our probability density functions that we utilize in our mathematical calculations.

What is claimed is:

1. A cybersecurity risk analysis system comprising:
Structural data and formats for organizing effects and relationships between cybersecurity threats, risks, vulnerabilities and capabilities;
A mathematical algorithm for measuring the financial level of risk for an entire enterprise as well as for individual vulnerabilities;

2. The system in accordance with claim 1, operated in a cloud hosting arrangement and deployed to one or more customers via internet access.

3. The system in accordance with claim 1, wherein the system utilizes external security scanning techniques to derive at least some risk-related data and incorporates these results into the operation of the algorithmic risk valuation.

4. The system in accordance with claim 1, wherein the system utilizes a unique combination of probability density functions, pareto analysis, Galois set theory calculations, Markov Chains and differential equations to accomplish the results of the algorithm

5. The system in accordance with claim 1, wherein the system utilizes a published Application Program Interface (API) to allow the output data and results of the invention to be integrated with customer-owned systems and technologies not supplied by the owner of the invention.

6. The system in accordance with claim 1, wherein the system utilizes a portal technology to provide access to the various functions and features of the invention, and to allow users to input specific data, view the results of the invention, and process other interactions in support of the operation of the invention.

7. The system in accordance with claim 1, wherein the system utilizes a distributed ledger technology to aid in securing the output data of customers using the invention and allowing any un intended alterations to, or access of, the data used in the invention to be identified and corrected.
The invention may be provided to parties or companies or organizations intending to use the invention to assess or evaluate the cybersecurity of third parties, as part of the conduct of their own business and in support of their efforts to understand certain cybersecurity risks associated with their interactions and transaction with those third parties.
The invention may provide certain information to aid in the determination of risk in financial terms for certain insurance considerations including the risk rating of cybersecurity matters in order to perform insurance policy underwriting, pricing, premium calculation, and the insurability of specific companies or organizations.
